(19) United States
(12) Patent Application Publication
(10) Pub. No.: US 2011/0074650 A1
(43) Pub. Date: Mar. 31, 2011

(54) ANTENNA MODULE AND HOUSING HAVING THE SAME

(75) Inventors: ZHAN LI, Santa Clara, CA (US); YE XIONG, Shenzhen (CN); WEI-DONG HAO, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/721,655

(22) Filed: Mar. 11, 2010

(30) Foreign Application Priority Data
Sep. 30, 2009 (CN) 200910308053.9

(51) Int. Cl. H01Q 1/38; H01Q 1/42

(52) U.S. Cl. 343/872; 343/700 MS; 977/773; 977/932

(57) ABSTRACT

An antenna module includes a supporting layer, a plurality of antenna layers; and at least one insulating layer. The antenna layers are conductive nanometric material formed on the supporting layer. The at least one insulating layer defines at least one through hole therein between and electronically connecting each two adjacent antenna layers to form an FM radiator. A housing utilizing the antenna module is also described.

### BACKGROUND

1. Technical Field

The present disclosure relates to antenna modules, and particularly, to an antenna module of nanometric material used with a wireless communication device.

2. Description of Related Art

Many portable electronic devices, such as mobile phones, personal digital assistants (PDAs) and laptop computers utilize frequency modulation (FM) signals.

However, many portable wireless communication devices lack FM antennas for receiving FM signals. Rather, external accessories such as earphones are used as FM antennas to receive FM signals, in which case the accessories must be inserted/connected to the portable electronic device to provide the FM signal receiving function. Thus, it is necessary to transport the earphone with the portable electronic device to receive FM transmissions.

Therefore, there is room for improvement within the art.

### BRIEF DESCRIPTION OF THE DRAWINGS

Many aspects of the antenna module and housing having the same can be better understood with reference to the following drawings. The components in the drawings are not necessarily drawn to scale, the emphasis instead being placed upon clearly illustrating the principles of the antenna module. Moreover, in the drawings, like reference numerals designate corresponding parts throughout the several views, in which:

FIG. 1 is a cross-section of an antenna module according to an exemplary embodiment;

FIG. 2 is a cross-section of a housing having a base integrally formed with the antenna module shown in FIG. 1.

### DETAILED DESCRIPTION

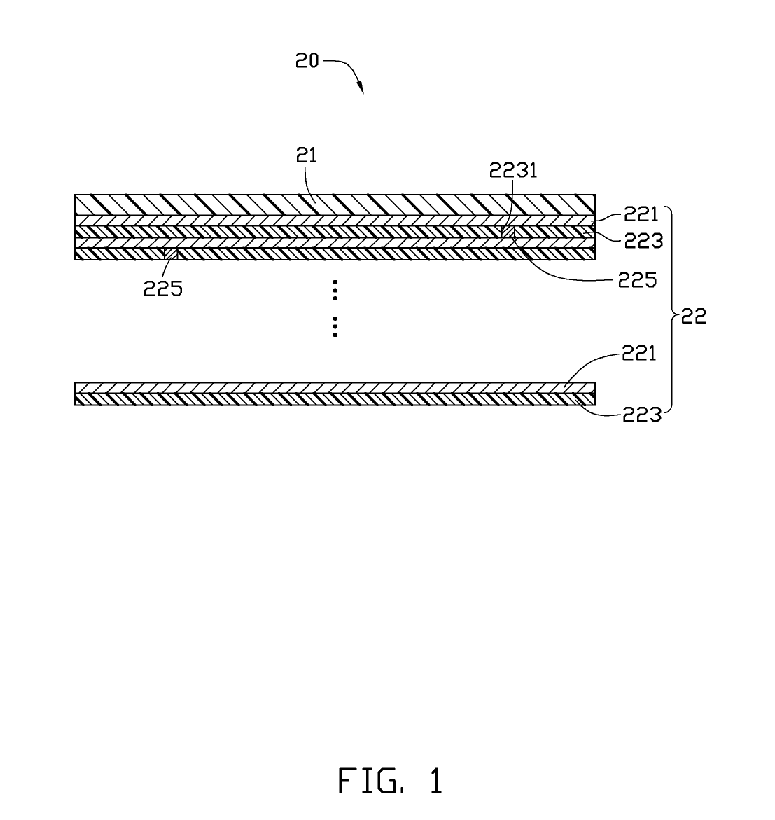

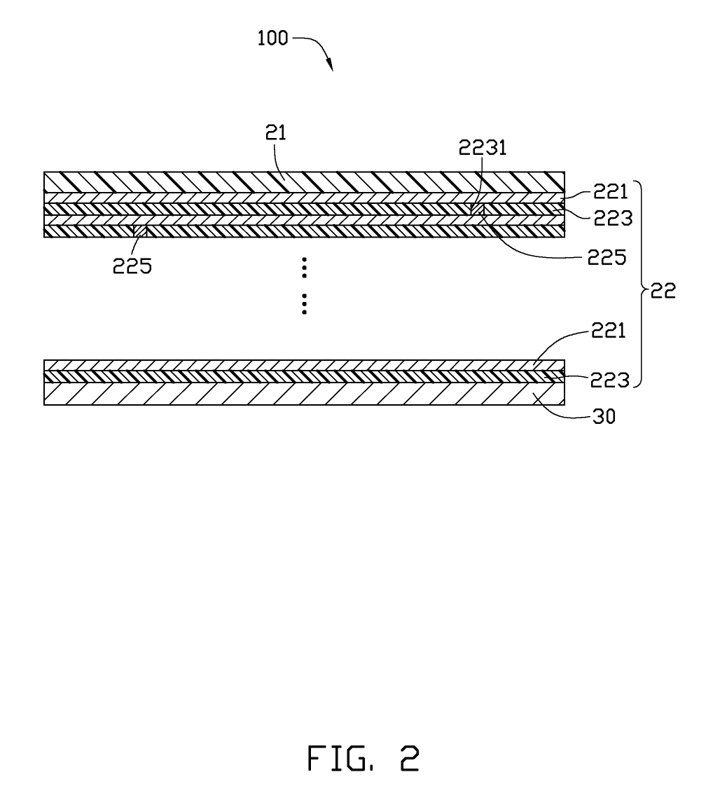

FIGS. 1 and 2 show an exemplary antenna module 20 used in a housing 100 of a wireless communication device. The antenna module 20 includes a supporting layer 21 and an antenna element 22 formed to the supporting layer 21. The antenna element 22 includes a plurality of antenna layers 221, a plurality of insulating layers 223 positioned between each two adjacent antenna layers 221, and a plurality of conductive portions 225 configured to electronically connect the antenna layers 221. Each of the insulating layers 223 excepting the last defines a through hole 2231 to receive the conductive portion 225. The antenna layers 221 connected by the conductive portions 225 form an FM radiator to receive FM signals for wireless communication devices.

The supporting layer 21 is resin such as polycarbonate, acrylonitrile butadiene styrene, or polyethylene glycol terephthalate resin.

The antenna layers 211 can be formed by printing films of ink including conductive nanometric material, forming a FM radiating pattern including main radiator and supplementary radiator configured to receive signals for the wireless communication device.

In a first exemplary embodiment, the conductive nanometric material is conductive nanometer calcium carbonate, fabricated of calcium carbonate (CaCO₃), symb (Sn), and antimony (Sb). The mass ratio of CaCO₃:Sn:Sb is approximately 55˜90:9-40:1˜10, using nanometer calcium carbonate as nucleosome and forming tin dioxide doped with an antimony coating on the nanometer calcium carbonate surface by chemical co-deposition.

In a second exemplary embodiment, the conductive nanometric material is conductive ink composition. The conductive ink composition includes 30˜85% by weight of metal nanoparticles, 10˜60 wt % of an organic solvent, 10˜30 wt % of a humectant of a diol or glycol base compound, and 0.1˜10 wt % of an additive for adjusting viscosity made of an ethylene base ether compound.

The metal nanoparticles used in the conductive ink may be nanoparticles of silver (Ag), gold (Au), copper (Cu), nickel (Ni), palladium (Pd), platinum (Pt), or alloy thereof. The particle diameter of the metal nanoparticles may be 20˜50 nanometer (nm), with smaller particle sizes easing formation of drops for ejection.

The organic solvent used in the conductive ink composition is a hydrophilic solvent of water, ethanol, methanol, propanol, or other.

The humectant adjusts the drying speed at the inkjet head and maintains humidity. The humectant may be a diol or glycol base compound.

The additive may be triethyleneglycol dimethyl ether, triethyleneglycol monobutyl ether, triethyleneglycol monoethyl ether, diethyleneglycol diethyl ether, diethyleneglycol monobutyl ether, diethyleneglycol dibutyl ether, ethyleneglycol monopropyl ether, or dipropyleneglycol methyl ether.

In a third exemplary embodiment, the conductive nanometric material is nanometer metal dispersed in liquid. Raw material of the nanometer metal dispersion liquid includes: 5˜70% by weight metallics, 0.01˜55 wt % nitrogenous, oxygen, sulphur and/or boron atom/functional group, 0˜30 wt % additive, and 0.01-20 times as much as that of a) b) c) or the solvent of arbitrary ingredient material weight.

Metals can be copper, gold, silver, molybdenum, nickel, niobium, aluminum, platinum, led, tin, titanium, indium, gallium, selenium, or alloy thereof, and the additive can include stabilizer, catalyst, chain extender, cross-linking agent, coupling agent, filler, modifier, emulsifier, reinforcing agent, curing agent, thickening agent, humectant, plasticizing agent, chelating agent, defoaming agent, solubilizer, polymerization inhibitor, rheology modifier, surfactant, lubricant, adhesive, nucleating agent, processing aid, buffer, polyvinyl butyral (PVB), polyvinyl alcohol (PVA) or other thermoplastic polymers. The solvent can be water, deionized water, alcohol, ester class, ketones or ether organic solvent.

In a forth embodiment, the conductive nanometer is made of high concentration nanometer metal particle. The high concentration nanometer metal particle includes golden nanoparticles or platinum nanoparticles and a superficial stabilizer. The golden nanoparticles or platinum nanoparticlesare in concentration of greater than 1% by weight with a diameter of less than or equal to 5 nm.

The insulating layers 223 can be printed by dielectric ink films to reduce the Electrical Magnetic Interference (EMI) of the adjacent antenna layers 221.

The antenna element 22 is made of nanometric material, thus, the volume of the wireless communication device is decreased.

During manufacturing the antenna module 20, the conductive ink is printed on the supporting layer 21 to form an antenna layer 221. Then dielectric ink can be printed on the surface of the antenna layer 221 to form an insulating layers 223. The insulating layer 223 defines the through hole 2231 through which the antenna layer 221 is exposed. Conductive ink introduced through the through hole 2231 forms the conductive portion 225 by electronically connecting the adjacent antenna layers 221. The process is repeated to form the antenna module 20.

The housing 100 includes a base 30. The antenna module 20 is integrally formed with the base 30 by injection molding. The base 30 can be resin such as silicone resin, thermoplastic resin, or other.

During manufacture of the housing 100, the antenna module 20 is received in an injection mold (not shown). The supporting layer 21 is attached to the injection mold. The resin is injected into the injection mold. The base 30 is formed on the last insulating layer 223 and located opposite to the supporting layer 21.

It is believed that the present embodiments and their advantages will be understood from the foregoing description, and it will be apparent that various changes may be made thereto without departing from the spirit and scope of the disclose or sacrificing all of its material advantages, the examples hereinbefore described merely being preferred or exemplary embodiments of the disclosure.

What is claimed is:

1. An antenna module comprising:
a supporting layer;
a plurality of antenna layers; and
at least one insulating layer;
wherein the antenna layers are conductive nanometric material formed on the supporting layer; the at least one insulating layer defining at least one through hole thereby electronically connecting each two adjacent antenna layers to form an FM radiator.

2. The antenna module as claimed in claim 1, wherein the conductive nanometric material is calcium carbonate.

3. The antenna module as claimed in claim 2, wherein the calcium carbonate is formed by proportioning the mass ratio of CaCO₃, Sn, and Sb as CaCO₃:Sn:Sb=55˜90:9˜40:1˜10, using nanometer calcium carbonate as nucleosome and forming tin dioxide doped with an antimony coating on the nanometer calcium carbonate surface by chemical co-deposition.

4. The antenna module as claimed in claim 1, wherein the nanometric material is conductive ink composition.

5. The antenna module as claimed in claim 4, wherein the conductive ink composition comprises metal nanoparticles, organic solvent, humectant, and an additive for adjusting viscosity.

6. The antenna module as claimed in claim 5, wherein the ratio of the metal nanoparticles comprises 30˜85% by, weight; 10˜60 wt % of the organic solvent, 10˜30 wt % of the humectant made of a diol or glycozl base compound, and 0.1˜10 wt % of an ethylene base ether compound.

7. The antenna module as claimed in claim 6, wherein the conductive nanometric material comprises nanoparticles of metals such as silver, gold, copper, nickel, palladium, platinum, or an alloy thereof.

8. The antenna module as claimed in claim 6, wherein the particle diameter of the metal nanoparticles equals about 20˜50 nm.

9. The antenna module as claimed in claim 1, wherein the conductive nanometric material is a nanometer metal dispersion liquid.

10. The antenna module as claimed in claim 9, wherein the raw material of the nanometer metal dispersion liquid includes 5˜70% by weight metal, 0.01˜55 wt % nitrogenous, oxygen, sulphur and/or boron atom/functional group; 0˜30 wt % additive, and 0.01-20 times the weight thereof or a solvent of arbitrary ingredient material weight.

11. The antenna module as claimed in claim 1, wherein the conductive nanometer comprises high concentration nanometer metal particles.

12. The antenna module as claimed in claim 11, wherein the high concentration nanometer metal particles comprise gold or platinum nanoparticles and a superficial stabilizer, wherein the gold or platinum nanoparticle solids in the high concentration equal or exceed 1% by weight with a diameter less than or equaling 5 nm.

13. A housing comprising:
a antenna module; and
a base attached to the antenna module;
wherein the antenna module comprises a supporting layer, a plurality of antenna layers, and at least one insulating layer wherein the antenna layers comprise conductive nanometric material formed on the supporting layer, the at least one insulating layer defines at least one through hole thereby electronically connecting each two adjacent antenna layers to form an FM radiator.

14. The housing as claimed in claim 13, wherein the conductive nanometric material is calcium carbonate.

15. The housing as claimed in claim 14, wherein the calcium carbonate is formed by proportioning the mass ratio of CaCO₃, Sn, and Sb as CaCO₃:Sn:Sb=55˜90:9˜40:1˜10, using nanometer calcium carbonate as nucleosome and forming tin dioxide doped with an antimony coating on the nanometer calcium carbonate surface by chemical co-deposition.

16. The housing as claimed in claim 13, wherein the conductive nanometric material is conductive ink composition comprising metal nanoparticles, organic solvent, humectant, and an additive for adjusting viscosity.

17. The housing as claimed in claim 13, wherein the conductive nanometric material is nanometer metal dispersion liquid.

18. The housing as claimed in claim 17, wherein the raw material of the nanometer metal dispersion liquid includes 5˜70% by weight metal, 0.01˜55 wt % nitrogenous, oxygen, sulphur and/or boron atom/functional group; 0˜30 wt % additive, and 0.01-20 times the weight thereof or a solvent of arbitrary ingredient material weight.

19. The housing as claimed in claim 13, wherein the conductive nanometer comprises high concentration nanometer metal particles.

20. The housing as claimed in claim 19, wherein the high concentration nanometer metal particles comprise gold or platinum nanoparticles and a superficial stabilizer, wherein the gold or platinum nanoparticle solids in the high concentration equal or exceed 1% by weight with a diameter less than or equaling 5 nm.
